(19) United States
(12) Patent Application Publication
(10) Pub. No.: US 2011/0031955 A1
(43) Pub. Date: Feb. 10, 2011

(54) CONSTANT CURRENT DEVICE

(75) Inventors: Ching-Chi Cheng, Hsintien (TW); Wen-Hsiang Chien, Hsintien (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ADVANCED-CONNECTEK, INC., Hsintien (TW)

(21) Appl. No.: 12/715,535

(22) Filed: Mar. 2, 2010

(30) Foreign Application Priority Data
Aug. 5, 2009 (TW) 098126351

(51) Int. Cl. G05F 3/16

(52) U.S. Cl. 323/312

(57) ABSTRACT

A constant current device in accordance with the present invention is connected to an external voltage source and comprises an input unit, a driving transistor and a voltage control unit. The input unit is connected to the external voltage source. The driving transistor is used to output constant current. The voltage control unit makes the driving output constant current and comprises at least one resistor and a semiconductor load, and has a resistor voltage, the resistor comprising an input and an output.

### FIELD OF THE INVENTION

The present invention relates to a constant current device.

### BACKGROUND OF THE INVENTION

Conventional constant current devices are used to control current flowing through other devices. Constant current devices are particularly advantageous when used with light emitting diodes (LEDs) because a constant current flowing through LEDs makes light emitted from the LEDs steady and remains life of LEDs.

With reference to FIG. 1, a conventional LED device comprises an LED module (12), a power supply (11), a reference voltage (Vᵣ), a constant current driver (10) (i.e. a constant current device) and a resistor (R).

The LED module (12) comprises at least one LED and an output and has an output current. The LEDs in the LED module (12) may be connected in series, parallel or both.

The power supply (11) supplies direct current or rectified alternating current to the LED module (12).

The reference voltage (Vᵣ) is constant.

The constant current driver (10) is connected to the output of the LED module (12), senses and regulates current flowing through the LED module (12), has an output current and output voltage (V_{O}) and comprises an error sensor (101) and a transistor (102).

The output voltage (V_{O}) is a pulsating DC voltage.

The error sensor (101) may be an operational amplifier and comprises a source, a ground, an inverted input, a control input and an output.

The source is connected to the output of the LED module (12).

The inverted input senses voltage at the output of the constant current driver (10).

The control input is connected to the reference voltage (Vᵣ).

The output generates an error signal by comparing the output voltage (Vₒ) and the reference voltage (Vᵣ).

The transistor (102) comprises a drain, a gate and a source and has a gate voltage, an equivalent resistance, a drain voltage, a drain current and a channel. The drain is connected to the output of the LED module (12) and the source of the error sensor (101). The gate is connected to the output of the error sensor (101). The gate voltage is the error signal. The equivalent resistance is adjusted by the gate voltage to make the output voltage equal the reference voltage (Vᵣ). The drain voltage is greater than the gate voltage and is between the drain and the source. The drain current has a magnitude, flows from the drain to the source and the magnitude of the drain current is controlled by the gate voltage and the width of the channel. Therefore, if the magnitude of the drain current increased, the width of the channel need to be increased, too.

The resistor (R) has an input and an output and drops a voltage proportional to the current flowing through the resistor (R). The input of the resistor (R) is connected to the source of the transistor (102) and the inverted input of the error sensor (101). The output of the resistor (R) is connected to the ground.

Since the output current of the constant current driver (10) is equal to the drain current and has been limited by the gate voltage is under the drain voltage, if the output current needs increase, the width of the channel must increase. So the manufacturing cost of the constant current driver (10) increasing based on the width of the channel, too.

### SUMMARY OF THE INVENTION

The objective of the present invention is to provide a device that generates a constant current.

The constant current device in accordance with the present invention is connected to an external voltage source and comprises an input unit, a driving transistor and a voltage control unit.

The input unit has an input and an output and is connected to the external voltage source.

The driving transistor is used to output constant current.

The voltage control unit makes the driving transistor output constant current and comprises a semiconductor load and at least one resistor and has a resistor voltage. The resistor comprising an input and an output.

### BRIEF DESCRIPTION OF THE DRAWINGS

FIG. 1 is a circuit diagram of a conventional light emitting diode (LED) driving device;

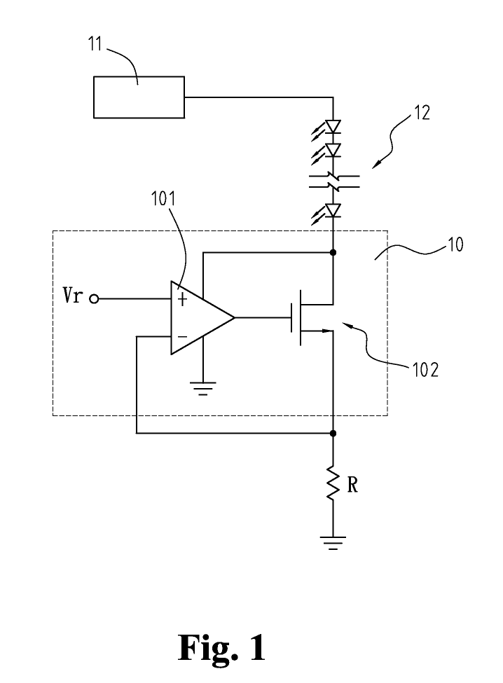

FIG. 2 is a circuit diagram of a constant current device in accordance with the present invention;

FIG. 3 is a circuit diagram of a first embodiment of the constant current device in FIG. 2;

FIG. 4 is a circuit diagram of a second embodiment of the constant current device in FIG. 2;

FIG. 5 is a circuit diagram of a third embodiment of the constant current device in FIG. 2;

FIG. 6 is a circuit diagram of a fourth embodiment of the constant current device in FIG. 2; and

FIG. 7 is a circuit diagram of a fifth embodiment of the constant current device in FIG. 2.

### DETAILED DESCRIPTION OF THE PRESENT INVENTION

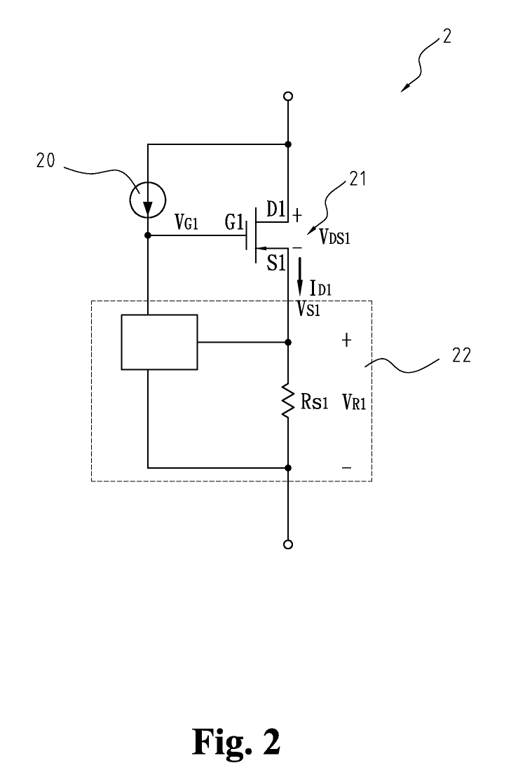

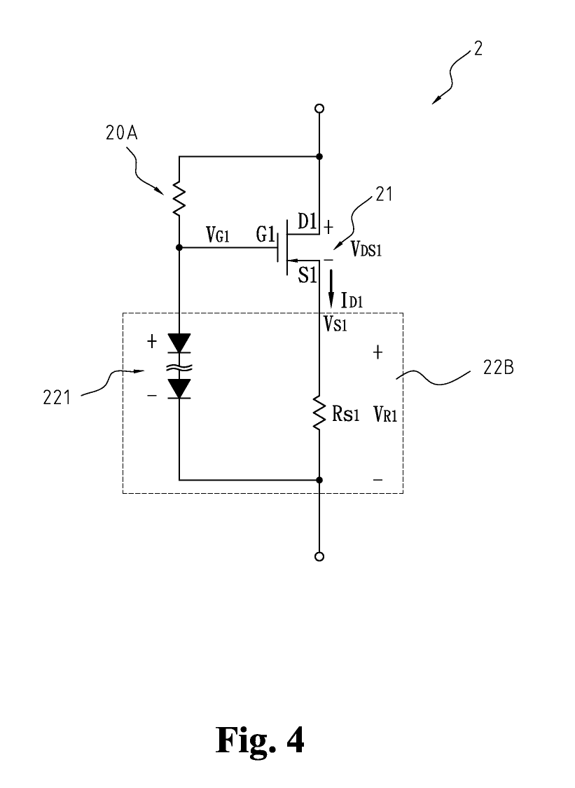

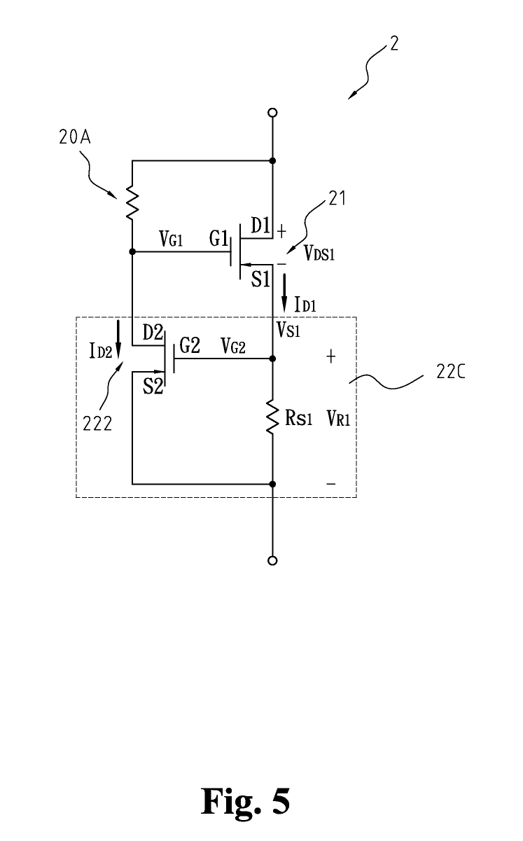

With reference to FIGS. 2 to 7, a constant current device (2) in accordance with the present invention is connected to an external voltage source, and comprises an input unit (20), a driving transistor (21) and a voltage control unit (22). The constant current device (2) may be used in a solid state light device and a conventional triode for alternating current dimmer. The external voltage source may be a rectified alternating voltage source or a direct voltage source.

The input unit (20) can vary a voltage across it to maintain a constant current, may be an input resistor (20A) or an input circuit (20B) and has an input and an output. The input is connected to the external voltage source.

The input resistor (20A) has an input and an output.

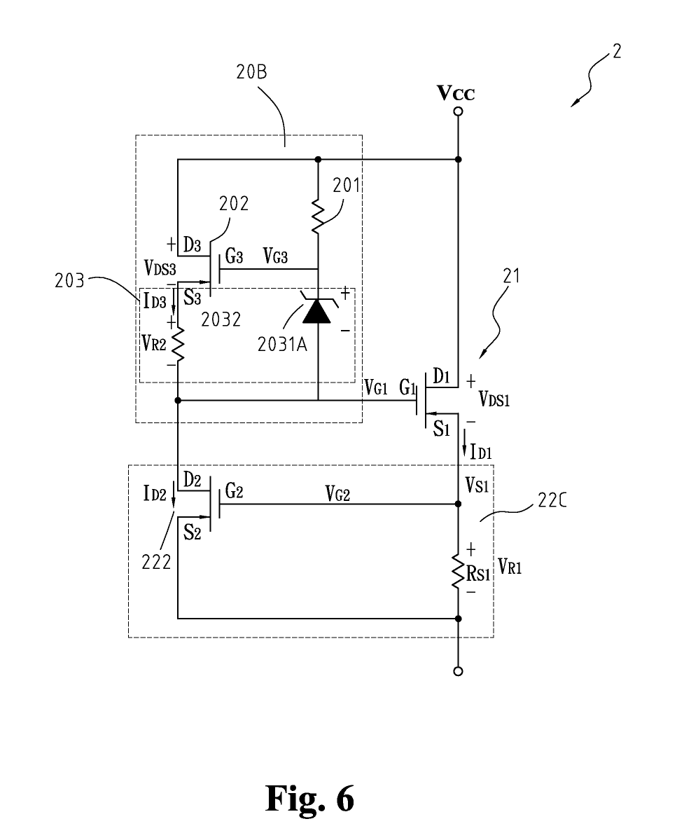

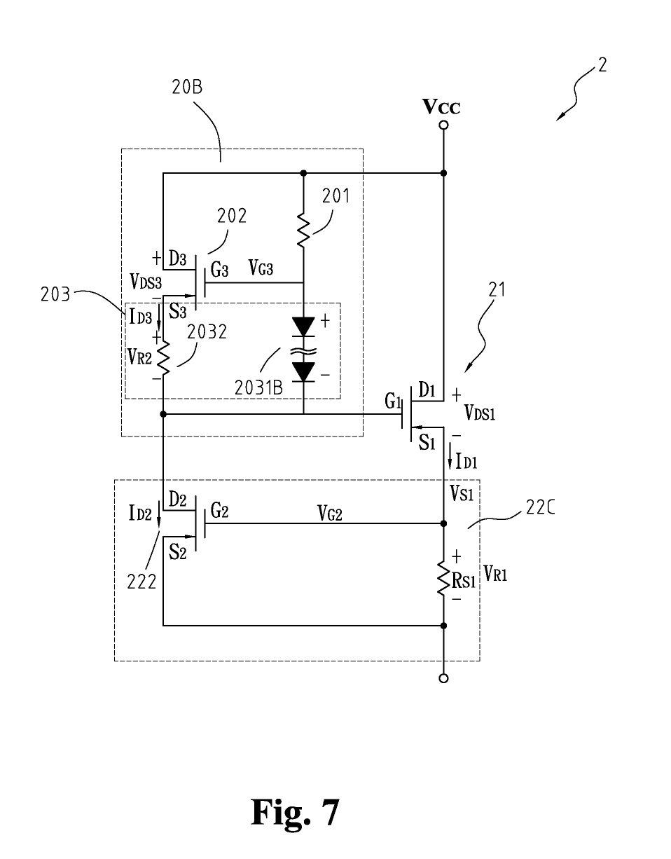

With reference to FIGS. 6 to 7, the input circuit (20B) comprises an auxiliary input resistor (201), a constant current transistor (202) and an auxiliary voltage control unit (203).

The auxiliary input resistor (201) is connected to the external voltage source, divides voltage from the external voltage source and has an input and an output.

The constant current transistor (202) is used to output constant current and comprises a drain (D3), a gate (G3) and a source (S3) and has a drain current (I_{D3}), a gate voltage (V_{G3}) and a drain voltage (V_{DS3}) drops from the drain (D3) to the source (S3). The drain (D3) is connected to the external voltage source. The gate (G3) is connected to the output of the auxiliary input resistor (201). The drain current (I_{D3}) flows through the constant current transistor (202) and is a constant current. The gate voltage (V_{G3}) controls how much drain current (I_{D3}) flows through the constant current transistor (202).

The auxiliary voltage control unit (203) makes the constant current transistor outputs constant current and comprises at least one auxiliary resistor (2032) and an auxiliary semiconductor load.

The auxiliary resistor (2032) comprises an input, an output and a resistor voltage (V_{R2}). The input is connected to the source (S3) of the constant current transistor (202). The resistor voltage (V_{R2}) is produced by the drain current (I_{D3}) flowing through the auxiliary resistor (2032) and controls the gate voltage (V_{G3}).

The auxiliary semiconductor load is used to make the gate voltage (V_{G3}) of constant current transistor (202) constant and may be at least one zener diode (2031A) or multiple diodes (2031B) and has an input and an output. The input of the auxiliary semiconductor load is connected to the gate (G3) of the constant current transistor (202). The output is connected to the output of the at least one auxiliary resistor (2032).

With reference to FIGS. 2 to 7, the driving transistor (21) may be an NMOS transistor (N-type metal-oxide-semiconductor transistor) or an NPN transistor (N-P-N bipolar transistor). The driving transistor (21) is used to output constant current and may comprise a drain (D1), a gate (G1) and a source (S1) and may have a threshold voltage (V_{TH}), an inner resistance, a drain voltage (V_{DS1}), a drain current (I_{D1}) and a saturation mode. The drain (D1) is connected to the external voltage source. The drain current (I_{D1}) flows from the drain (D1) through the driving transistor (21) and has a magnitude. The gate (G1) is connected to the input unit (20) and has a gate voltage (V_{G1}). The gate voltage (V_{G1}) controls the magnitude of the drain current (I_{D1}) when the driving transistor (21) works on the saturation mode. The source (S1) comprises source voltage (V_{S1}). The drain voltage (V_{DS1}) is between the drain (D1) and the source (S1). The saturation mode is a mode that the driving transistor (21) passes the most current and has a condition. The condition is V_{G1}−(V_{TH}+V_{S1})<V_{DS1}. Since the drain voltage (V_{DS1}) is always greater than the gate voltage (V_{G1}) minus the threshold voltage (V_{TH}) and the source voltage (V_{S1}) so the driving transistor (21) is always works on the saturation mode.

The voltage control unit (22, 22A, 22B, 22C) makes the driving transistor (21) output constant current and comprises at least one resistor (R_{S1}) and a semiconductor load (220, 221, 222) and has a resistor voltage (V_{R1}). The resistor voltage (V_{R1}) is voltage across the resistor (R_{S1}) that is produced by the drain current (I_{D1}) flowing through the resistor (R_{S1}), and the resistor voltage (V_{R1}) controls the gate voltage (V_{G1}) of the driving transistor (21).

The at least one resistor (R_{S1}) comprises an input and an output. The input is connected to the source (S1) of the driving transistor (21).

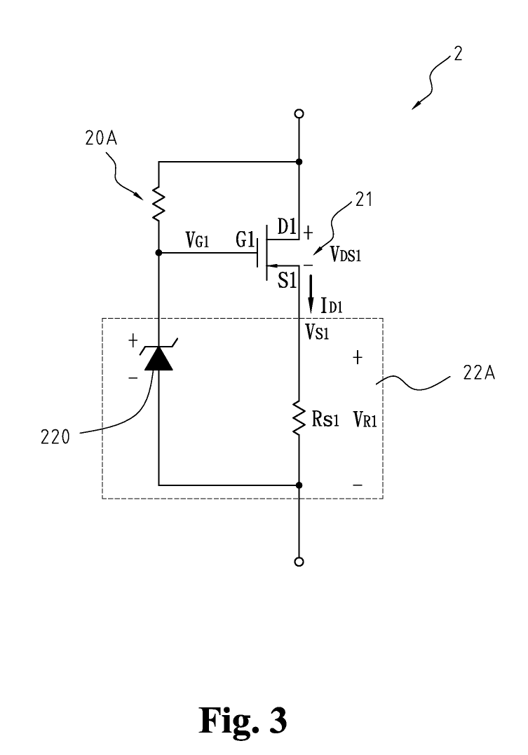

With reference to FIGS. 3 to 5, the semiconductor load (220, 221, 222) is used to make the gate voltage (V_{G1}) of the driving transistor (21) constant and may be a zener diode (220), multiple diodes (221) or a transistor (222).

The zener diode (220) comprises an anode and a cathode, has a breakdown voltage and makes the gate voltage (V_{G1}) is a stable voltage when the voltage of the external voltage source increases, then the drain current (I_{D1}) is constant. The cathode of the zener diode (220) is connected to the input unit (20). The anode of the zener diode (220) is connected to the output of the resistor (R_{S1}). The breakdown voltage corresponds to the threshold voltage (V_{TH}) of the driving transistor (21).

The multiple diodes (221) connected in series and comprise an input and an output and have a cut-in voltage. The cut-in voltage is equal to the gate voltage (V_{G1}) to make the drain current (I_{D1}) constant. The input of the multiple diodes (221) is connected to the input unit (20). The output of the multiple diodes (221) is connected to the output of the resistor (R_{S1}).

The transistor (222) comprises a drain (D2), a gate (G2) and a source (S2). The transistor (222) makes the gate voltage (V_{G1}) of the driving transistor (21) to be a stable voltage, so the drain current (I_{D1}) is constant. The drain (D2) is connected to the gate (G1) of the driving transistor (21) and the input unit (20). The gate (G2) of the transistor (222) is connected to the input of the resistor (R_{S1}) and has gate voltage (V_{G2}) that equal to the resistor voltage and is constant. The source (S2) of the transistor (222) is connected to the output of the resistor (R_{S1}).

Accordingly, the constant current device of the present invention using the driving transistor to outputs constant current. Since the design of transistor is simple than the operational amplifier's and the drain voltage of the transistor has not be limited, hence the manufacturing cost can lower than the conventional constant current devices.

Various changes can be made without departing from the broad spirit and scope of the invention.

What is claimed is:

1. A constant current device being connected to an external voltage source and comprising
an input unit can vary a voltage across it to maintain a constant current and having an input being connected to the external voltage source; and
an output;
a driving transistor being used to output constant current; and
a voltage control unit making the driving transistor outputting constant current and having
a resistor voltage being voltage across the resistor; and comprising
at least one resistor comprising an input and an output; and
a semiconductor load.

2. The constant current device as claimed in claim 1, wherein the driving transistor comprises
a drain being connected to the external voltage source;
a gate being connected to the input unit and has a gate voltage; and
a source comprising source voltage; and has
a threshold voltage;
an inner resistance;
a drain voltage being between the drain and the source;
a drain current flowing from the drain through the driving transistor and having a magnitude; and
a saturation mode being a mode that the driving transistor passing the most current, when the driving transistor working on the saturation mode, the gate voltage controlling the magnitude of the drain current.

3. The constant current device as claimed in claim 2, wherein
the voltage control unit controls the gate voltage by the resistor voltage;
the semiconductor load is used to make the gate voltage of the driving transistor constant;
the resistor voltage is voltage across the resistor and being produced from the drain current flowing through the resistor; and
the input of the resistor is connected to the source of the driving transistor.

4. The constant current device as claimed in claim 1, wherein the external voltage source is a rectified alternating voltage source.

5. The constant current device as claimed in claim 1, wherein the driving transistor is an N-type metal-oxide-semiconductor transistor.

6. The constant current device as claimed in claim 1, wherein the external voltage source is a direct voltage source.

7. The constant current device as claimed in claim 1, wherein the driving transistor is an N—P—N bipolar transistor.

8. The constant current device as claimed in claim 1, wherein the input unit is an input resistor that has an input and an output.

9. The constant current device as claimed in claim 2, wherein the semiconductor load is a zener diode, and the zener diode comprises
an anode being connected to the output of the resistor; and
a cathode being connected to the input unit; and has
a breakdown voltage corresponding to the threshold voltage of the driving transistor.

10. The constant current device as claimed in claim 2, wherein the semiconductor load is multiple diodes connected in series, has
a cut-in voltage being equal to the gate voltage to make the drain current constant; and comprises
an input being connected to the input unit; and
an output being connected to the output of the resistor.

11. The constant current device as claimed in claim 2, wherein the semiconductor load is a transistor, and the transistor comprises
a drain being connected to the gate of the driving transistor and the input unit;
a gate being connected to the input of the resistor and having a gate voltage that equal to the resistor voltage and constant; and
a source being connected to the output of the resistor.

12. The constant current device as claimed in claim 1, the constant current device can be used in a solid state light device.

13. The constant current device as claimed in claim 1, the constant current device can be used in a conventional triode for alternating current dimmer.

14. The constant current device as claimed in claim 1, wherein the input unit is an input circuit comprising
an auxiliary input resistor having an input and an output, being connected to the external voltage source and dividing voltage from the external voltage source;
a constant current transistor being used to output constant current and comprising
a drain being connected to the external voltage source;
a gate being connected to the output of the auxiliary input resistor;
a source;
a drain current flowing through the constant current transistor and being a constant current;
a gate voltage controlling how much drain current flowing through the constant current transistor; and
a drain voltage dropping from the drain to the source; and
an auxiliary voltage control unit making the constant current transistor outputting constant current and comprising
at least one auxiliary resistor comprising
an input being connected to the source of the constant current transistor;
an output;
a resistor voltage dropping across the auxiliary resistor and being produced by the drain current flowing through the auxiliary resistor and controlling the gate voltage; and
an auxiliary semiconductor load being used to make the gate voltage of constant current transistor constant and having
an input being connected to the gate of the constant current transistor; and
an output being connected to the output of the at least one auxiliary resistor.

15. The constant current device as claimed in claim 14, wherein the auxiliary semiconductor load is at least one zener diode.

16. The constant current device as claimed in claim 14, wherein the auxiliary semiconductor load is multiple diodes.
